(19) United States
(12) Patent Application Publication
(10) Pub. No.: US 2012/0094044 A1
(43) Pub. Date: Apr. 19, 2012

(54) Internally-illuminated three-dimensional hollow structure and manufacturing method therefor

(76) Inventor: Kenji Hashimoto, Osaka (JP)

(21) Appl. No.: 13/375,195

(22) PCT Filed: Jun. 5, 2009
(86) PCT No.: PCT/JP2009/060381

§ 371 Date: Dec. 30, 2011

(51) Int. Cl. B32B 1/08; B29C 65/50

(52) U.S. Cl. 428/35.7; 156/196

(57) ABSTRACT

[Problem]

The structure of the present invention is to provide an internally-illuminated three-dimensional hollow structure, which specifically has a high level of night-time visibility and can also bear weather conditions, such as rain water and wind, wherein a natural concavity and convexity configuration can be formed even if the structure is a complicated shape, and a framework configuration cannot be seen through even during internal illumination since the framework is a large-sized frame, even if coloration of the structure has high brightness or high saturation.

[Solution)

The internally-illuminated three-dimensional hollow structure, is provided, wherein a three-dimensional framework is formed from main reinforcements and reinforcing bars, then an undercoating is applied throughout this framework, a synthetic resin tape is provided on a concave part of this framework, and if necessary, a two-sided adhesive tape is stick to a convex part of the framework, thereby forming a framework body, and wherein after the synthetic resin sheet is expanded throughout and temporarily attached to surface of this framework body, the synthetic resin sheet is welded on the framework body and synthetic resin sheet ends are welded each other so that an integrated synthetic resin sheet is formed, and an illuminating device is set up inside of this framework.

The present invention relates to an internally-illuminated three-dimensional hollow structure used for commercial sign billboard and illumination, and its manufacturing method.

### BACKGROUND OF THE INVENTION

The sign-shaped object is used day and night for the purpose of a billboard and an indicator etc. in commercial facilities such as restaurants and recreational facilities. In order to improve their visibility, especially at night, there are a number of internally-illuminated structures with illuminating devices installed inside thereof.

Generally, those obtained by molding and processing acrylic resin and by expanding a synthetic resin sheet to its framework are used as an internally-illuminated sign-shaped object. However, when an acrylic resin is used, it is unsuitable for a large-sized structure due to its high likelihood of breakage, and thus its use was limited to the small structures. Alternatively, when the synthetic resin sheet is used, many clamps are required at the peripheral parts of the sheet in order for the sheet to expand to a framework, and the sheet has to have strength enough to bear expansion tension. Due to these facts, it has been difficult to apply the synthetic resin to a complex, concave-convex structure, although it could be used on a nearly flat structure.

In order to solve the problem described above, an internally-illuminated three-dimensional billboard with a flexible sheet is proposed (See the patent documents 1 and 2).

The technology disclosed in the patent document 1 sterically displays a target advertisement by uplifting a translucent and flexible synthetic resin sheet. Specifically, a part of the synthetic resin sheet is doubled to expand throughout the framework, and a gas is introduced into this double structure part to keep the part in a pressurized state, thereby forming a three-dimensional part.

On the other hand, the technology disclosed in the patent document 2 expands a non-porous, translucent, and flexible synthetic resin sheet throughout a framework of a three-dimensional billboard and depressurize the inside of the three-dimensional billboard, thereby forming a concave portion. However, both inventions described in the patent documents 1 and 2 must be large enough, because they need devices for supplying or exhausting air. Besides, they are inappropriate for a complicated-shape structure.

An example of the large, internally-illuminated three-dimensional structure having a complicated-shape structure is Nebuta. The Nebuta has square timbers as struts, and its framework is formed with wires. For the parts with much concavity and convexity, such as a face, hands, and foot, their frameworks are formed for every part, respectively, and then a framework of the Nebuta body is assembled by putting these parts together. An illuminating device is arranged inside of the assembled framework and Japanese paper (Washi) is applied along the framework.

By employing the method as described above, it is allowed to make the complicated-shape structure having concavity and convexity. However, when the Japanese paper is applied on a concave portion of the structure, it causes deflection and wrinkles on the paper. Therefore, it was difficult to make the finish natural. In addition, since the size of Japanese paper to be applied is as large as that of a newspaper at a maximum, the framework must be formed in the shape of a small frame to match this size. Due to this, when illuminated from inside by the illuminating device, the framework in the shape of a small frame of the whole structure can be visible. Therefore, in order to hide the shadow of the framework during internal illumination, Nebuta's coloration must have low brightness and no saturation, and thus it has been difficult to make a colorful structure. Additionally, since the Nebuta is formed with Japanese paper, it was susceptible to weather such as rain or wind, and has a drawback that it could not bear a long period of use.

Prior-Art Documents
Patent document 1: Tokukaihei5-273927
Patent document 2: Jitsukaihei7-5181

### SUMMARY OF THE INVENTION

The structure of the present invention is to provide an internally-illuminated three-dimensional hollow structure, which specifically has a high level of night-time visibility and can also bear weather conditions, such as rain water and wind, wherein a natural concavity and convexity configuration can be formed even if the structure is a complicated shape, and a framework configuration cannot be seen through even during internal illumination since the framework is a large-sized frame, even if coloration of the structure has high brightness or high saturation.

### Means for Solving the Problems

The invention according to claim 1 relates to an internally-illuminated three-dimensional hollow structure, wherein a three-dimensional framework is formed from main reinforcements and reinforcing bars, then an undercoating is applied throughout this framework, a synthetic resin tape is provided on a concave part of this framework, and if necessary, a two-sided adhesive tape is stick to a convex part of the framework, thereby forming a framework body, and wherein after the synthetic resin sheet is expanded throughout and temporarily attached to surface of this framework body, the synthetic resin sheet is welded on the framework body and end of the synthetic resin sheet are welded each other so that an integrated synthetic resin sheet is formed, and an illuminating device is set up inside of this framework.

The invention according to claim 2 relates to an internally-illuminated three-dimensional hollow structure, wherein a structural material is set up and integrated inside of the framework.

The invention according to claim 3 relates to an internally-illuminated three-dimensional hollow structure, wherein each of the main reinforcements, reinforcing bars, and structural materials consists of metal materials, respectively.

The invention according to claim 4 relates to an internally-illuminated three-dimensional hollow structure according to any of claims 1-3, wherein the synthetic resin sheet has flexibility and translucency.

The invention according to claim 5 relates to an internally-illuminated three-dimensional hollow structure according to any of claims 1-4, wherein the undercoating, the synthetic resin tape, the two-sided adhesive tape, and the synthetic resin sheet are polyvinyl chloride synthetic resin.

The invention according to claim 6 relates to an internally-illuminated three-dimensional hollow structure according to any of claims 1-5, wherein rupture elongation of the synthetic resin sheet is 300 to 500%/7 kg (0.4 mm in film thickness, and 50 mm in length×20 mm in width).

The invention according to claim 7 relates to a method of manufacturing an internally-illuminated three-dimensional hollow structure, comprising;

(1) forming a framework having concavity and convexity by bending main reinforcements and reinforcing bars concavely or convexly and by using the bended main reinforcements and reinforcing bars,

(2) forming a framework body by applying an undercoating throughout the framework, by providing a synthetic resin tape on a concave part of this framework, and if necessary, by sticking a two-sided adhesive tape to a convex part of the framework,

(3) setting up an illuminating device inside of the framework or the framework body after either the framework formation process (1) or the framework body formation process (2),

(4) expanding and temporarily attaching a weldable synthetic resin sheet having flexibility and translucency along the surface of the framework body,

(5) welding on the framework the synthetic resin sheet temporarily attached to the framework body,

(6) mutually welding end of the synthetic resin sheet welded on the framework body so that an integrated synthetic resin sheet is formed, and

(7) coloring the synthetic resin sheet welded on the framework body, if necessary.

The invention according to claim 8 relates to the method of manufacturing an internally-illuminated three-dimensional hollow structure according to claim 7, comprising coloring the synthetic resin sheet welded on the framework body after the process (6).

### Effects of the Invention

According to the invention of claim 1, a framework is formed with main reinforcements and reinforcing bars, and thus a shape of the structure can be held regardless of its size (large size or small size). Since an undercoating is applied on the framework and a synthetic resin tape is provided on a concave part of the framework, and if necessary, a two-sided adhesive tape is stick to a convex part of the framework, application of a large-area of the synthetic resin sheet does not cause deflection or wrinkle. Therefore, since the framework of the structure can be provided in a large frame, the framework can be prevented from being seen through during internal illumination, and the coloring can have high brightness or high saturation. Moreover, smooth texture is obtained on the surface of the structure because overlapping portions of ends of the synthetic resin sheet are welded each other so that an integrated synthetic resin sheet is formed. Furthermore, since an illuminating device is set up inside of the framework of the structure, the device emits lights in all directions inside of the structure when illuminating the lights and the structure has a high level of night-time visibility. In addition, the structure can also bear weather conditions, such as rain water and wind.

According to the invention of claim 2, there is no possibility that adequate strength of even a larger structure can be maintained and shape of the structure cannot be damaged, since a structural material is set up and integrated inside of the framework.

According to the invention of claim 3, since each of the main reinforcements, reinforcing bars, and structural materials consists of metal materials, respectively, the structure's framework can maintain its strength and prevent its degradation.

According to the invention of claim 4, since the synthetic resin sheet has flexibility and translucency, the structure with even complicated concavity and convexity can take on a natural shape and internal illumination emits lights in all directions inside of the structure and have high level of night-time visibility.

According to the invention of claim 5, since an undercoating, a synthetic resin tape, a two-sided adhesive tape, and a synthetic resin sheet can be polyvinyl chloride synthetic resin, the structure can have high weldability into metal materials forming a framework and superior resistance to adverse weather conditions.

According to the invention of claim 6, since rupture elongation of the synthetic resin sheet is 300 to 500%/7 kg (0.4 mm in film thickness, and 50 mm in length×20 mm in width), an internally-illuminated three-dimensional hollow structure without any deflection can be provided even if it is a complicated three-dimensional structure.

According to the invention of claim 7, the method has an effect that an internally-illuminated three-dimensional hollow structure regarding this invention can be surely and appropriately manufactured.

According to the invention of claim 8, the coloration can be provided with high brightness or high saturation, and an internally-illuminated three-dimensional hollow structure with a high level of night-time visibility can be manufactured.

### BRIEF DESCRIPTION OF FIGURES

FIG. 1 shows an example of a framework of an internally-illuminated three-dimensional hollow structure.

FIG. 2 shows that an undercoating is applied on the framework.

FIG. 3 shows an example of (a) a synthetic resin tape provided on a concave part of the framework and (b) a two-sided adhesive tape stick to a convex part of the framework.

FIG. 4 shows that the synthetic resin sheet is expanded on the framework with an illuminating device set up therein.

FIG. 5 shows that the synthetic resin sheet is ultrasonically-welded.

FIG. 6 shows that an adhesive bond is applied and welded on overlapping portions of end of the synthetic resin sheet welded on the framework.

FIG. 7 shows an example of the framework of the internally-illuminated three-dimensional hollow structure with regard to the present invention, which is covered with the synthetic resin sheet.

FIG. 8 shows that an illuminating device set up inside of the internally-illuminated three-dimensional hollow structure with regard to the present invention is lit.

FIG. 9 shows an example of an embodiment of the internally-illuminated three-dimensional hollow structure with regard to the present invention.

### DETAILED DESCRIPTION OF THE INVENTION

Hereinafter, embodiments of the internally-illuminated three-dimensional hollow structure with regard to the present invention will be explained with reference to drawings.

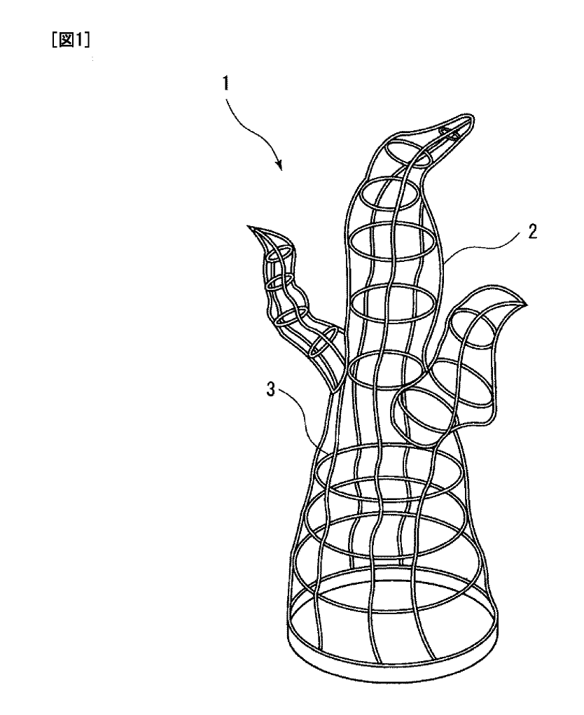

FIG. 1 shows an example of a framework of an internally-illuminated three-dimensional hollow structure with regard to the present invention. The framework (1) consists of a main reinforcement (2) and a reinforcing bar (3). The main reinforcement (2) forms appearance configuration of the three-dimensional structure, and the reinforcing bar (3) reinforces the main reinforcement (2) to maintain the configuration of the three-dimensional structure. In the embodiment of this invention, the reinforcing bar (3) is a hoop reinforcement, but is not limited to this. As a material of the framework (1), metal materials, such as iron and aluminum, or synthetic resin and complexes thereof can be used, and for example, a reinforcing steel bar is preferably used.

The main reinforcement (2) is concavely or convexly bent to fit the appearance configuration of the three-dimensional structure. Known tools can be used for this bending, and it is preferable to use a bending tool that can make fine adjustment of bending angle.

In this invention, diameter of the materials used for the main reinforcement (2) and the reinforcing bar (3) is preferably 4-13 mm. If the diameter is less than 4 mm, the main reinforcement (2) and the reinforcing bar (3) are easy to process, but cannot have strength enough to maintain the shape of the three-dimensional structure. On the other hand, if the diameter exceeds 13 mm, they have sufficient strength but are difficult to make fine adjustment of bending angle. Therefore, neither of the cases is desirable.

If the three-dimensional structure is large, it is preferable to set up, for instance, a steel frame (not shown) inside of the framework (1) as a structural material in order to obtain strength enough to maintain the shape. Furthermore, the steel frame and the main reinforcement (2) may be jointed with supplement reinforcement (not shown) to reinforce the main reinforcement (2).

Inside the framework (1), an illuminating device, which is not shown in the FIG. 1, is setup. The number of the illuminating device to be setup can be chosen depending on the desired intensity of illumination. After the illuminating device is set up, the framework (1) is covered with the synthetic resin sheet as described below. Therefore, it is preferable to setup the illuminating device in the position that does not cause thermal loss, scorching, or burning etc. of the synthetic resin sheet because of heat generated by lighting the illuminating device.

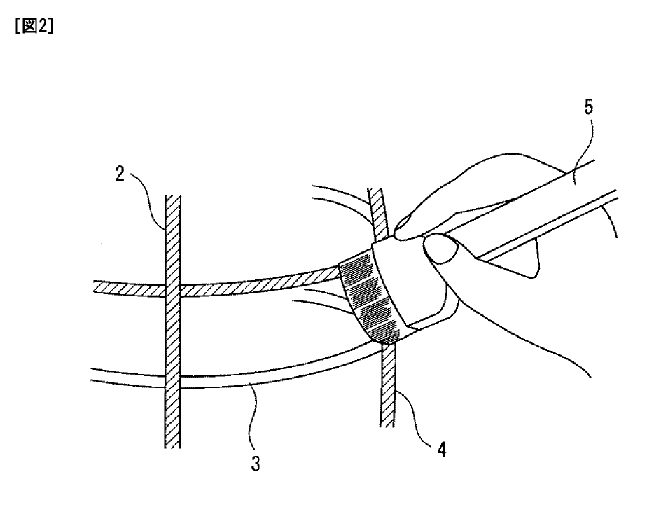

Before sticking a synthetic resin sheet (6) to the framework, an undercoating (4) is applied on the surface of the main reinforcement (2) and the reinforcing bar (3) of the framework (1) (See FIG. 2). By applying the undercoating (4), adhesion between the synthetic resin sheet (6) and a material which forms the framework (1), especially a metal material, can be enhanced, and thus detachment of the synthetic resin sheet (6) caused by the weather or temporal deterioration can be prevented. The method of applying this undercoating (4) is not specifically limited. Spraying the undercoating can be used, but using a brush (5) as shown in FIG. 2 is efficient.

As the undercoating (4), a thermoplastic resin or a thermosetting resin is preferably used. The examples of the resin include a polyvinyl chloride resin, an epoxy resin, a phenolic resin, etc. For example, a polyvinyl chloride resin plastic paint (brand name: “VINY-COAT#2000” made from HIGASHI NIPPON TORYO CO., LTD) and a modified epoxy resin (brand name: “HI-PON 20” made from NIPPON PAINT Co., Ltd.) can be used.

In order to improve the adhesion between the synthetic resin sheet (6) and the framework (1) formed with metal materials, a top coating paint (not shown) made of a synthetic resin may be applied on the undercoating (4). As the top coating paint, a thermoplastic resin is preferably used, and it includes for example, a polyvinyl chloride plastic paint (a brand name: “Labarraque” manufactured by the Nippon Paint Co., Ltd. and a brand name: “VINY-COAT#2000” manufactured by HIGASHI NIPPON TORYO CO., LTD).

Furthermore, a paint, to which chromatic or achromatic pigment is added, can also be applied on the framework (1), but the pigment added to the paint is preferably white, because the synthetic resin sheet (6) to be expanded is white for the convenience of coloration. The paint, to which the pigment is preliminarily added, can be used, but those obtained by adding the white pigment to the above-mentioned synthetic resin may be used. The white pigment includes a zinc oxide, a zinc sulfide, a barium sulfate, a titanium oxide etc. and any of them is preferable used.

Covering with the synthetic resin sheet (6) on the complicated concavo-convex structure easily causes deflection and detachment. Especially in a concave part, wrinkles can readily appear and thus color unevenness can appear during coloration. Thus, finished products cannot obtain smooth texture. Therefore, by covering a concave main reinforcement (2) and reinforcing bar (3) of the framework (1) with a synthetic resin tape (7), the thickness of underlying film layer of the framework (1) is increased to prevent deflection and detachment of the synthetic resin sheet (6). In addition, if the undercoating (4) or the top coating paint is applied and the synthetic resin tape or the two-sided adhesive tape mentioned later is applied on the framework (1), a framework body (1a) is obtained.

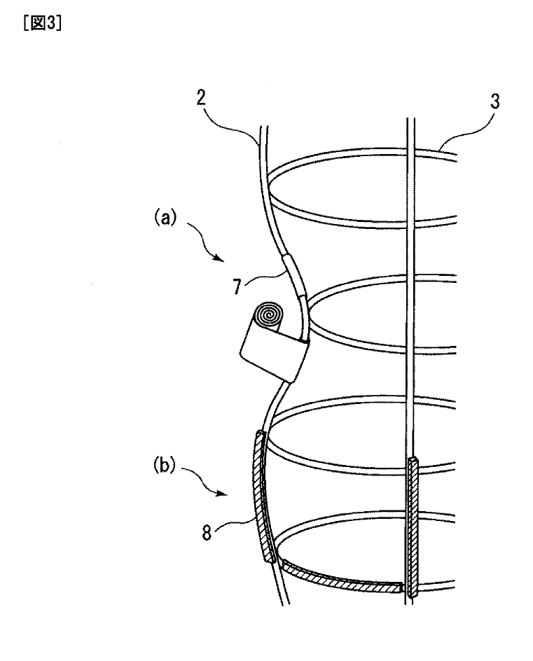

FIG. 3 (a) shows an example of the concave main reinforcement (2) of the framework (1) covered with the synthetic resin tape (7) (the undercoating (4) etc. is abbreviated in the figure). FIG. 3 (a) shows that the synthetic resin tape (7) is wound around the concave main reinforcement (2) of the framework (1), but the covering method is not limited to this. Thus, the synthetic resin tape (7) is provided on the concave part of the framework (1) to expand the synthetic resin sheet (6) and attach it with its tension applied. In the present invention, it is desirable to temporarily attach the synthetic resin sheet (6) prior to welding it to the framework body (1a). It causes no deflections or wrinkles so that a smooth concave shape is obtained.

On the other hand, a two-sided adhesive tape is stick to the convex part of the framework. FIG. 3 (b) shows an example of the two-sided adhesive tape (8) stick to the convex part of the framework (1) (the undercoating (4) etc. is abbreviated). The two-sided adhesive tape (8) is stick to the convex part having a radius of curvature of greater than 1000 mm. It allows the synthetic resin sheet (6) to expand and to be attached with its tension applied.

If the radius of curvature is less than 1000 mm, the synthetic resin sheet (6) can be stick to the framework body (1a) by the same way as the tape is stick to the concave part.

Since the above-mentioned process is performed on the concave part and convex part of the framework (1) to obtain the framework body (1a), the synthetic resin sheet (6) is expanded and welded after temporal attachment, and it allows the framework body (1a) to be covered, with big tension maintained during the expansion. Furthermore, if gaps between the main reinforcements (2) and the reinforcing bars (3) are large, respectively, i.e. the framework (1) (the framework body (1a)) with the shape of large frame consists of less main reinforcements (2) and less reinforcing bars (3), there is no possibility of causing deflections, wrinkles, or detachment etc.

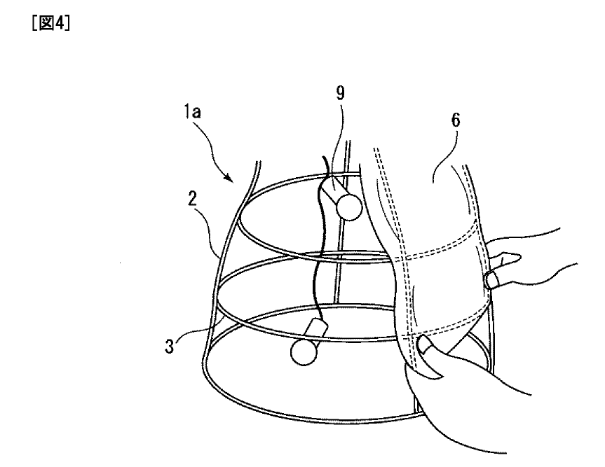

FIG. 4 shows an example of a synthetic resin sheet (6) expanded and temporarily attached to the framework body (1a) of which an illuminating device (9) is set up inside. The synthetic resin sheet (6) used in the present invention has flexibility and translucency, and it is preferably a thermoplastic resin. The thermoplastic resin includes polyvinyl chloride, polypropylene, polyethylene, polystyrene, polyvinyl acetate, acrylic resin, etc. Due to its superior strength and durability against deterioration, polyvinyl chloride is preferably used. In order to provide flexibility with polyvinyl chloride, it is preferable to add a plasticizer, phthalate ester. The phthalate ester used as a plasticizer is chosen from dioctyl phthalate, diisononyl phthalate, diisodecyl phthalate, and dibutyl phthalate, etc.

Besides, the synthetic resin sheet (6) is preferably white for the convenience of coloration as described later. Although the white synthetic resin sheet (6) can be obtained by adding a white pigment at the time of synthetic resin sheet molding, the pigment can include zinc oxide, zinc sulfide, barium sulfate, titanium oxide, etc., and the titanium oxide is preferably used. If the titanium oxide is used as a white pigment, the crystal structure of titanium oxide is preferably a rutile structure. By blending the rutile-structural titanium oxide with the synthetic resin sheet (6), deterioration of the synthetic resin sheet (6) by ultraviolet rays can be prevented, even if a structure with this synthetic resin sheet (6) is installed outdoors.

A related synthetic resin sheet (6) can preferably include a polyvinyl chloride sheet (brand name: “P satin finished surface clear” manufactured by KOUSEIKASEI) which comprises as a plasticizer 80 dioctyl phthalate etc. with respect to 100 polyvinyl chloride and is prepared by adding titanium oxide.

The synthetic resin sheet (6) may be not only a single layer of thermoplastic resin but also a multilayer structure, and at least one layer is preferably polyvinyl chloride. For example, those obtained by laminating polyvinyl chloride and polyolefin resin such as polyethylene and polypropylene can be used as the synthetic resin sheet (6).

The rupture elongation of the synthetic resin sheet (6) is preferably 300 to 500%/7 kg (0.4 mm in film thickness, and 50 mm in length×20 mm in width), and is more preferably greater than 400%. In addition, the rupture elongation in the present invention shall mean the length of a test piece prior to the rupture (referred to as L1) to the length of a test piece after the rupture (referred to as L0), which is expressed in percentage (%) (see formula I as below).

$$L ( \% ) = \frac{{L}_{1}}{{L}_{0}} \times 100 \qquad [ Formula 1 ]$$

If the rupture elongation is less than 300%, the sheet becomes too rigid to expand, and can also be ruptured when expanding. On the other hand, if the rupture elongation exceeds 500%, the sheet becomes enough flexible to expand. However, deflections and wrinkles can be formed after welding, disfiguring the structure. Therefore, neither of the cases is preferable. Furthermore, the film thickness of the synthetic resin sheet (6) is not limited to 0.4 mm, but can be 0.4-0.7 mm. If the film thickness is less than 0.4 mm, the sheet has translucency in expansion but can be ruptured, and if the film thickness of the sheet exceeds 0.7 mm, the sheet has translucency but can be poor in expanding. Therefore, neither of the cases is preferable.

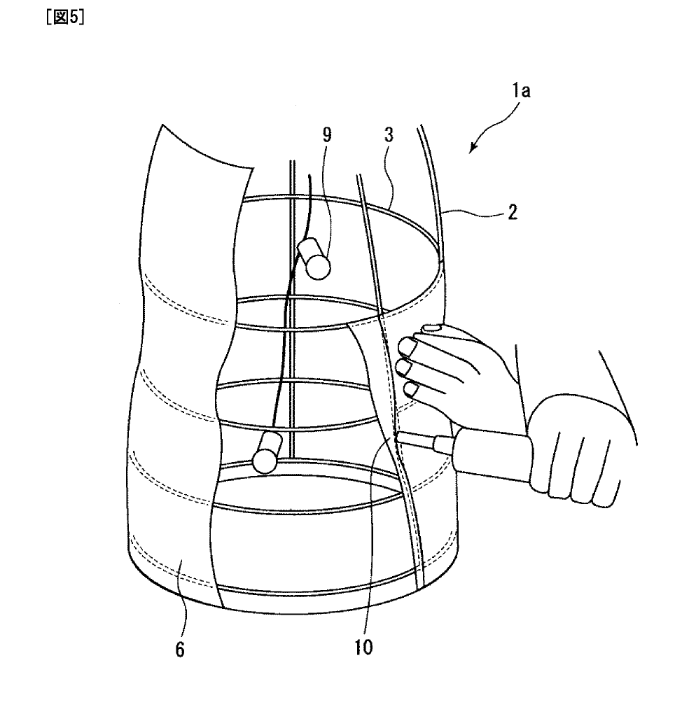

The temporarily attached synthetic resin sheet (6) is welded on the framework body (1a). FIG. 5 shows that the synthetic resin sheet (6) is ultrasonically-welded to the framework body (1a) (an ultrasonic welding portion is illustrated as a number (10)). The method of welding the synthetic resin sheet (6) to the framework body (1a) is not limited to ultrasonic welding, and high frequency welding and thermal adhesion etc can be used. Moreover, the synthetic resin sheet (6), the undercoating (4), and the synthetic resin tape (7) can also be mutually melted and welded with an adhesive bond.

Hereinafter, the welding cases by ultrasonic welding are explained below. Ultrasonic welding is a method of melting and jointing the synthetic resin sheet (6), which is a thermoplastic resin, by minute vibration (vibration generated by supersonic wave) and pressurization. Since a molecule vibrates with the supersonic wave, the temperature inside of the synthetic resin rises and thus the synthetic resin melts. Therefore, this method is suitable for the thermoplastic resin. A thermoplastic or thermosetting adhesive bond is applied on the framework body (1a) as an undercoating (4), ultrasonic welding does not directly act on this undercoating (4). It means that since the synthetic resin sheet (6) is a thermoplastic resin, the sheet (6) is welded on and stick to the framework body (1a) using the heat generated at the time of melting of the resin.

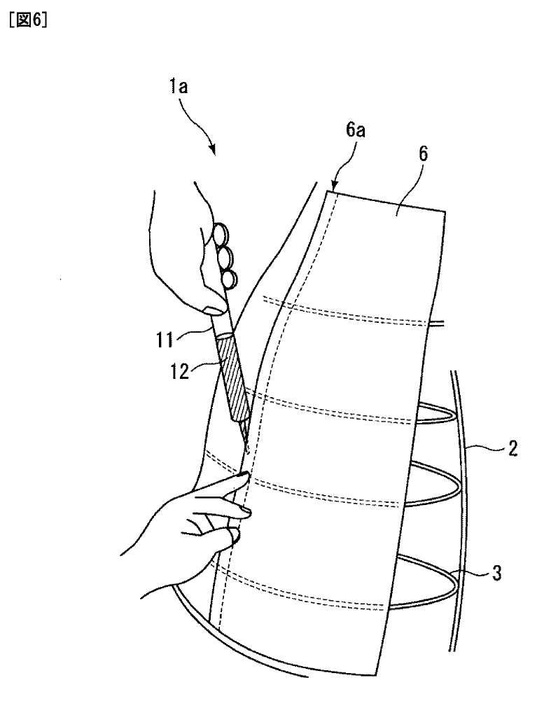

The synthetic resin sheet (6) is welded on the main reinforcement (2) and the reinforcing bar (3) of the framework body (1a), but overlapping portions (6a) of the synthetic resin sheet (6) are preferably welded with an adhesive bond in order that the sheet can become a single-shaped sheet and its finish can look beautiful. FIG. 6 shows that an adhesive bond (12) is applied on overlapping portions (6a) of the synthetic resin sheet (6) with an application member such as a syringe (11) so that the portions are welded. As the adhesive bond (12), for instance, tetrahydrofuran, cyclohexanone, etc. can be used, and tetrahydrofuran is preferably used. If these adhesive bonds (12) are used, the synthetic resin sheets mutually melt and then become hardened, and thus substantially no overlapping portions (6a) of ends of the synthetic resin sheet are left, so that the sheet can become a single sheet-shaped synthetic resin sheet (6). Therefore, even if the sheet has complicated concavity and convexity, smooth texture can be obtained.

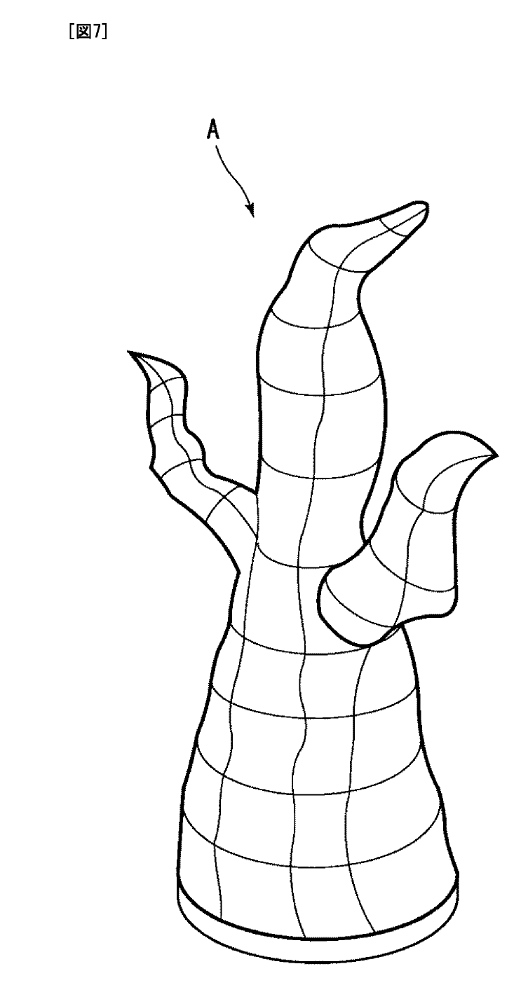

FIG. 7 shows an example of a framework (1) of the internally-illuminated three-dimensional hollow structure (A) covered with the synthetic resin sheet (6). The synthetic resin sheet (6) is welded by the method mentioned above, keeping the appearance of the framework (1). Besides, the internally-illuminated three-dimensional hollow structure (A) is colored so that its visibility can be improved more. General paint application can be used as a coloration method, and it can include, for example, a brush painting and an airbrush painting etc. Furthermore, it also allows for designing the surface of the internally-illuminated three-dimensional hollow structure (A) using a cutting sheet.

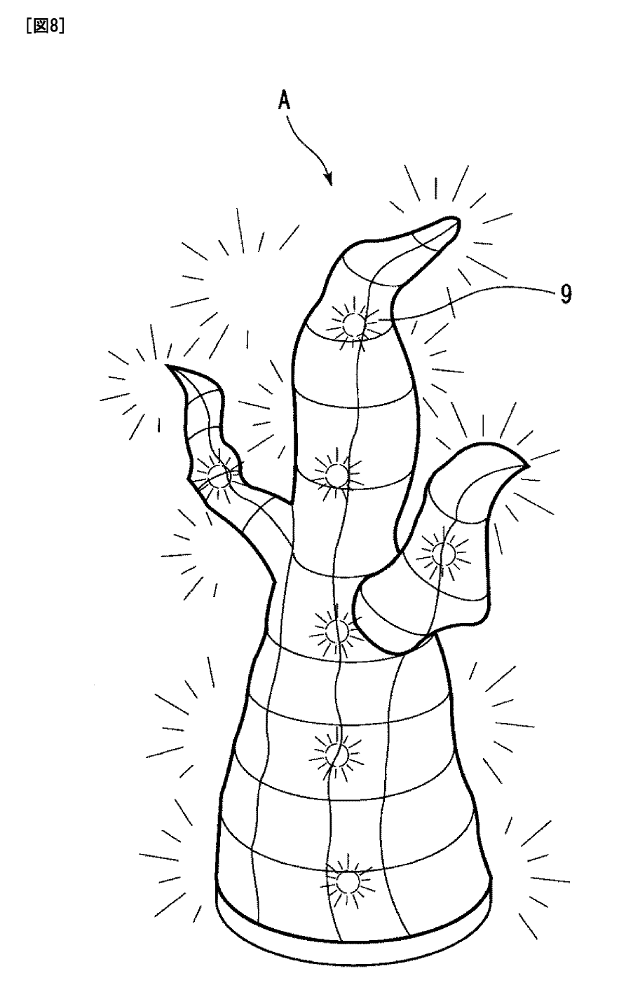

FIG. 8 shows that an illuminating device (9) set up inside of the internally-illuminated three-dimensional hollow structure (A) in FIG. 7 is lit. Since the synthetic resin sheet (6) has translucency, the illuminating device (9) emits lights in all directions inside of the structure when it is lit, and thus outline and color etc. of the structure can be visually-identified even at night when visually-identifying a structure is difficult.

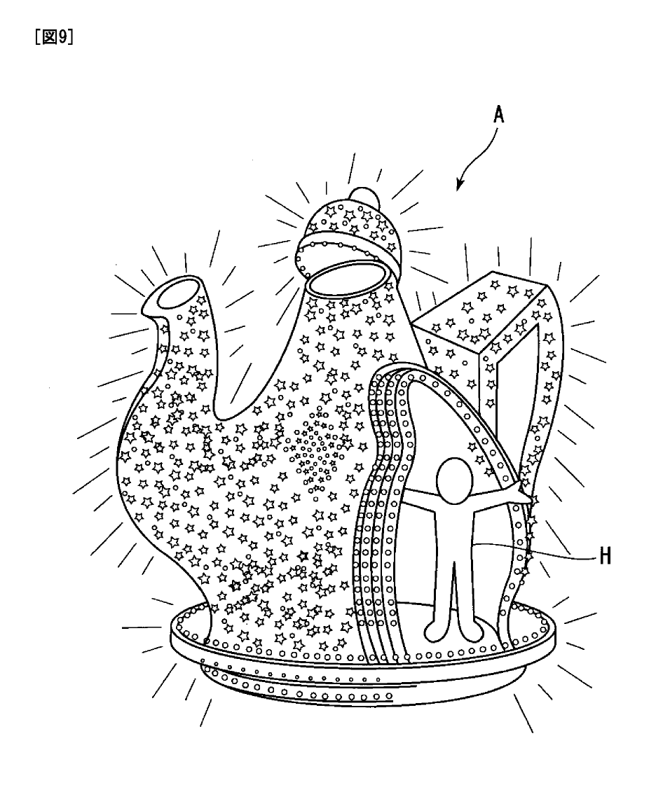

FIG. 9 shows an example of an embodiment of an internally-illuminated three-dimensional hollow structure (A) with regard to the present invention. In FIG. 9, the internally-illuminated three-dimensional hollow structure (A) is as high as about 10 m, and an illuminating device (9) is an example set up inside of the inside of the framework (1) of the structure and along outer surface of the internally-illuminated three-dimensional hollow structure (A). The internally-illuminated three-dimensional hollow structure with regard to this embodiment is so large that a person (H) can enter into the inside of the framework (1). Additionally, the structure can create a fantastic atmosphere by internally-illuminate the person (H) who enters the inside of the structure.

### INDUSTRIAL AVAILABILITY

The internally-illuminated three-dimensional hollow structure with regard to this embodiment and its manufacturing method can be preferably made available for illumination for home use, sign billboards for commercial facilities, and big exhibitions.

### EXPLANATION OF NUMBERS

1 . . . Framework
1a . . . . Framework body
2 . . . Main reinforcement
3 . . . Reinforcing bar
4 . . . Undercoating
6 . . . Synthetic resin sheet
6a . . . Overlapping portion of ends of a synthetic resin sheet
7 . . . Synthetic resin tape
8 . . . Two-sided adhesive tape
9 . . . Illuminating device
10 . . . Ultrasonic welding portion
12 . . . Adhesive bond
A . . . . Internally-illuminated three-dimensional hollow structure

1. An internally-illuminated three-dimensional hollow structure,
wherein a three-dimensional framework is formed from main reinforcements and reinforcing bars, then an undercoating is applied throughout said framework, a synthetic resin tape is provided on a concave part of said framework, thereby forming a framework body, and
wherein after said synthetic resin sheet is expanded on and temporarily attached to surface of said framework body, said synthetic resin sheet is welded on said framework body through said synthetic resin tape and ends of said synthetic resin sheet are mutually welded so that an integrated synthetic resin sheet is formed, and an illuminating device is set up inside of said framework.

2. The internally-illuminated three-dimensional hollow structure according to claim 1,
wherein a three-dimensional framework is formed from main reinforcements and reinforcing bars, then an undercoating is applied throughout said framework, a synthetic resin tape is provided on a concave part of said framework, and a two-sided adhesive tape is stick to a convex part of said framework having a radius of curvature of greater than 1000 mm, thereby forming a framework body, and
wherein after said synthetic resin sheet is expanded on and temporarily attached to surface of said framework body, said synthetic resin sheet is welded on said framework body through said synthetic resin tape and ends of said synthetic resin sheet are mutually welded so that an integrated synthetic resin sheet is formed, and an illuminating device is set up inside of said framework.

3. The internally-illuminated three-dimensional hollow structure according to claim 1 or 2,
wherein a structural material is set up and integrated inside of said framework.

4. The internally-illuminated three-dimensional hollow structure according to claim 3,
wherein each of said main reinforcements, reinforcing bars, and structural materials consists of metal materials, respectively.

5. The internally-illuminated three-dimensional hollow structure according to any of claims 1-4,
wherein said synthetic resin sheet has flexibility and translucency.

6. The internally-illuminated three-dimensional hollow structure according to any of claims 1-4,
wherein said undercoating, synthetic resin tape, two-sided adhesive tape, and synthetic resin sheet are polyvinyl chloride synthetic resin.

7. The internally-illuminated three-dimensional hollow structure according to any of claims 1-5,
wherein rupture elongation of said synthetic resin sheet is 300 to 500%/7 kg (0.4 mm in film thickness, and 50 mm in length×20 mm in width).

8. A method of manufacturing an internally-illuminated three-dimensional hollow structure, comprising;
(1) forming a framework having concavity and convexity by bending main reinforcements and reinforcing bars concavely or convexly and by using the bended main reinforcements and reinforcing bars,
(2) forming a framework body by applying an undercoating throughout said framework and by providing a synthetic resin tape on a concave part of said framework,
(3) setting up an illuminating device inside of said framework or said framework body after either said framework formation process (1) or said framework body formation process (2),
(4) expanding and temporarily attaching a weldable synthetic resin sheet having flexibility and translucency along the surface of said framework body,
(5) welding on said framework the synthetic resin sheet temporarily attached to said framework body through said synthetic resin tape, and
(6) mutually welding ends of said synthetic resin sheet welded on said framework body so that an integrated synthetic resin sheet is formed.

9. A method of manufacturing an internally-illuminated three-dimensional hollow structure, comprising;
(1) forming a framework having concavity and convexity by bending main reinforcements and reinforcing bars concavely or convexly and by using the bended main reinforcements and reinforcing bars,
(2) forming a framework body by applying an undercoating throughout said framework, by providing a synthetic resin tape on a concave part of said framework, and by sticking a two-sided adhesive tape to a convex part of said framework having a radius of curvature of greater than 1000 mm,
(3) setting up an illuminating device inside of said framework or said framework body after either said framework formation process (1) or said framework body formation process (2),
(4) expanding and temporarily attaching a weldable synthetic resin sheet having flexibility and translucency along the surface of said framework body,
(5) welding on said framework the synthetic resin sheet temporarily attached to said framework body through said synthetic resin tape, and
(6) mutually welding ends of said synthetic resin sheet welded on said framework body so that an integrated synthetic resin sheet is formed.

10. The method of manufacturing an internally-illuminated three-dimensional hollow structure according to claim 8 or 9,
comprising coloring the synthetic resin sheet welded on said framework body after the process (6).
